(19) United States
(12) Patent Application Publication
(10) Pub. No.: US 2026/0027746 A1
(43) Pub. Date: Jan. 29, 2026

(54) METHOD FOR MANUFACTURING PANELS AND PANELS OBTAINED THEREBY

(71) Applicant: UNILIN, BV, Wielsbeke (BE)

(72) Inventors: Matthias CLAERHOUT, Wielsbeke (BE); Wim REUBENS, Wielsbeke (BE); Toon BOURY, Wielsbeke (BE)

(21) Appl. No.: 18/994,311

(22) PCT Filed: Jul. 7, 2023
(86) PCT No.: PCT/IB2023/057020

§ 371 Date: Jan. 14, 2025

Related U.S. Application Data
(60) Provisional application No. 63/389,185, filed on Jul. 14, 2022.

(51) Int. Cl. B27D 5/00; B27F 1/06; E04F 15/02

(52) U.S. Cl. CPC B27D 5/006; B27F 1/06; E04F 15/02038; E04F 2201/023; E04F 2201/043

(57) ABSTRACT

A method for manufacturing panels such that the panels include a substrate and a decorative top layer. The decorative top layer has one or more lateral edges. The method includes the step of machining at least one of the lateral edges of the decorative top layer by a rotating milling cutter. The axis of the rotating milling cutter is tilted concerning the lateral edge in a first plane comprising the decorative top layer to thereby form a first angle with the normal of the lateral edge and/or is tilted in a second plane perpendicular to the lateral edge to thereby form a second angle with the first plane.

The present invention relates to a method for manufacturing panels and panels obtained or obtainable thereby. In particular the present invention relates to the manufacturing of decorative panels comprising a substrate and a decorative top layer applied thereto. In particular it may concern such decorative panels that comprise at at least one pair of opposite edges profiled edge regions having mechanical coupling means allowing to couple at least two such panels at the respective edges, wherein in a coupled condition a locking is obtained in a plane comprising the panels and perpendicular to the respective edges, and/or in a plane perpendicular to the respective edges.

It is known, for example from WO 97/47834, WO 2006/103565 and WO 2011/014113, to form profiled edge regions at opposite edges of panels by means of a plurality of consecutive cutting operations using rotating milling cutters. These cutting operations may be executed in a continuous milling machine or in a so-called double end-tenoner, wherein the panel to be machined is fed through the machine, and wherein the rotating milling cutters are positioned along the trajectory of the panel and are active on one or both edges of a pair of opposite edges that are parallel to the feeding direction. The decorative top layer of such panels may be thin and/or brittle, and the finishing of the lateral edges of the decorative top layer is prone to chipping and other defaults during the milling.

WO 2011/014113, by means of its FIG. 12b, discloses a tool setup that reduces chipping. Herein the rotating milling cutter that finishes the lateral edge of the decorative top layer is operating in the vertical plane and rotates in the feeding direction of the panel. The disclosed tool set-up may still lead to micro-chipping.

The present invention in the first place aims at an alternative method for manufacturing panels, wherein, in accordance with preferred embodiments, solutions are offered to one or more of the problems of the prior art. For example, the risk of chipping while machining the lateral edge may further be diminished.

With this aim, the present invention is a method for manufacturing panels, wherein said panels comprise a substrate and a decorative top layer, wherein said decorative top layer comprises one or more lateral edges, and wherein said method at least comprises the step of machining at least one of said lateral edges of said decorative top layer by means of a rotating milling cutter, with as a characteristic that the axis of said rotating milling cutter is tilted with respect to said lateral edge in a first plane comprising said decorative top layer to thereby form a first angle with the normal of said lateral edge and/or is tilted in a second plane perpendicular to said edge to thereby form a second angle with said first plane.

The tilted orientation of the axis of the rotating milling cutter in accordance with said first and/or said second angle allows a better definition and resultant optimization of the expected cutting forces. By choosing the inclination, it can be defined which point along the actively cutting circumferential portion of the rotating milling cutter is responsible for delivering the final cut of the lateral edge of the decorative top layer. This is in contrast to the prior art, where the milling cutter is active in the vertical plane with an axis normal to the lateral edge and the final lateral edge may be obtained at any point of the actively cutting circumferential portion of the cutting tool. It may even be obtained with that portion that exits and pulls on the decorative top layer, thereby leading to a higher chipping risk. With the present invention, possibilities are offered to more reliably counter chipping, and other edge defects, such as pushed-up edges.

Preferably, said decorative top layer comprises a printed decorative sheet, preferably a digitally printed decorative sheet, such as a paper sheet, and possibly additionally a wear layer applied on top of said printed decorative sheet. It is especially with such decorative top layers that the present invention may show its benefits to the largest extent. Decorative top layers comprising printed decorative sheets may be thin, for example 0.5 mm or less, and are vulnerable. Decorative top layers comprising a digitally printed decorative sheet may have a somewhat lesser splitting and/or delamination resistance due to the digitally applied ink forming a barrier for resin permeation from, for example, a resin impregnated paper sheet forming a wear layer.

Preferably, said decorative top layer comprises a cured thermohardening resin, such as a melamine containing resin. Thermohardening resins are notoriously brittle and prone to chipping or other edge defects.

According to the most preferred embodiment said decorative top layer comprises at least paper and thermohardening resin. The decorative top layer may for example be a so called DPL (Direct Pressure Laminate). Such decorative top layer may be obtained by assembling a stack comprising a board, one or more paper sheets and thermohardening resin, and treating said stack in a heated press treatment. Said thermohardening resin, for example a melamine resin, may previously have been provided on said one or more paper sheets. In the press treatment, the thermohardening resin is cured and said paper sheets are attached to said board, such as to an MDF or particleboard. Herein the thermohardening resin solidifies and takes care of the bounding with the board. Preferably said paper sheets at least comprise a printed decorative paper sheet, preferably a digitally printed decorative paper sheet, and/or a transparent or translucent paper sheet applied on top of said decorative paper sheet. It is clear that, in such case, said substrate of the eventual panels may be a portion of said board.

According to variants said decorative top layer may comprise a print performed on the substrate material or board, for example with the intermediary of one or more preparatory layers. Such print may be finished using one or more transparent or translucent layers, for example lacquer layers. According to another variant, said decorative top layer may comprise a vencer or another decorative top layer for example having a thickness of less than 1 mm, or even less than 0.5 mm.

Combinations of the abovementioned decorative top layers are not excluded. For example, the decorative top layer may comprise a vencer carrying a decorative print.

Said first angle and second angle may be chosen in a variety of manners, of which here below some possibilities are listed without desiring to be exhaustive.

According to a first possibility, the axis of said rotating milling cutter is tilted with respect to said lateral edge in said first plane to thereby form a first angle between 0 and 30° with the normal of said lateral edge. Preferably, said first angle is between 1 and 10°. The choice of relatively small angle allows obtaining a relatively large actively cutting circumferential portion of the rotation milling cutter, or in other words, a relatively large portion of the circumference of the cutter is engaged with the panel, while the point along said circumferential portion that cuts the final lateral edge is well defined. In this way a smooth cutting action, and a good distribution of cutting forces may be obtained.

Preferably, said first angle is such that, as seen from the motor driving said axis, said axis is pointing into the direction of a portion of said lateral edge that is machined. In this manner it is obtained that the point along said actively cutting circumferential portion that is responsible for cutting the final lateral edge enters the panel at a location where the decorative top layer is best supported by the remaining substrate material.

According to a second possibility, which may be combined with said first possibility, the axis of said rotating milling cutter is tilted in said second plane to thereby form a second angle between 0 and 30° with said first plane. Preferably said second angle is between 1 and 10°. Such slight inclination may optimize the obtained profile of the cut substrate material directly underneath the decorative top layer.

Preferably, said second angle is such that, as seen from the motor driving said axis, said axis is pointing into the direction of the normal of said decorative top layer.

The second possibility is of special importance when combined with said first possibility. For example when said rotating milling cutter comprises one or more cutting edges, wherein said cutting edges are perpendicular or nearly perpendicular, e.g. within 1°, to said axis, said first angle may lead to a less desired profile of the cut material directly underneath the decorative top layer, in that the profile may comprise a portion cut into the substrate material that extends in horizontal direction distally to beyond said lateral edge of said decorative top layer. Such profile may be undesirable, in particular when the obtained panels may be used adjacently. In such case a visible seam may be present between the lateral edges of the adjacent, e.g. mechanically coupled, panels. The present inventor has found that also using a slight tilt in accordance with said second angle can compensate this undesired effect, and may even create a slight undercut of the lateral edge of the decorative top layer, without increasing the risk of chipping to an unacceptable level.

According to a third possibility, that may be combined with said first possibility, the axis of said rotating milling cutter is in said first plane.

It is clear from the above, that said rotating milling cutter may comprise one or more cutting edges, wherein said cutting edges are perpendicular to said axis. According to a variant, that is of particular interest when said first and third possibility are used together, said rotating milling cutter comprises one or more cutting edges, wherein said cutting edges are profiled such that, in the radial direction, the cutting edge extends, in the axis direction, away from the motor driving said axis. The inventor has found that such cutting edge may also compensate for the above described undesirable profile of the cut material immediately underneath said decorative top layer.

In general, preferably, in said step of machining said panel is moved in a feeding direction into engagement with and over said rotating milling cutter. Preferably, the cutting action of said rotating milling cutter is mainly in said feed direction. In such case, the cutting forces are pushing the decorative top layer towards the substrate material, thereby further minimizing the risk of chipping or other defects at said one or more lateral edges. This preferred embodiment is of special interest in combination with the above mentioned first possibility, especially in combination with those cases where the first angle is such that, as seen from the motor driving said axis, said axis is pointing into the direction of a portion of said lateral edge that is machined.

In general, it is noted, that during said machining said panel may be directed with its decorative top layer facing downwards, i.e. upside down. The decorative top layer may be positioned against a transporting device, such as against a chain transporting device of the continuous milling machine.

Preferably, said panels comprise at least one pair of opposite edges, wherein said opposite edges comprise profiled edge regions having mechanical coupling means allowing to couple at least two such panels at the respective edges, wherein in a coupled condition a locking is obtained in a plane comprising the panels and perpendicular to the respective edges, and/or in a plane perpendicular to the respective edges. Preferably, in said coupled condition, lateral edges of the decorative top layer of the respective panels meet each other, preferably without play, or with a play smaller than 0.15 mm.

In accordance with the most preferred embodiment of the present invention in accordance with its first independent aspect, said rotating milling cutter shows the combination of the following three properties:
the property that the axis of said rotating milling cutter is tilted with respect to said lateral edge in a first plane comprising said decorative top layer, to thereby form a first angle of preferably between 0 and 30° with the normal of said lateral edge, and more preferably between 1 and 10°, wherein said first angle is preferably such that, as seen from the motor driving said axis, said axis is pointing into the direction of a portion of said lateral edge that is machined;
the property that the axis of said rotating milling cutter is tilted in a second plane perpendicular to said edge, to thereby form a second angle of preferably between 0 and 30° with said first plane, and more preferably between 1 and 10°;
the property that in said step of machining said panel is moved in a feeding direction into engagement with and over said rotating milling cutter, wherein the cutting action of said rotating milling cutter is mainly in said feed direction.

It is however clear, that any of the above properties in isolation, or in a combination of two or more is advantageous in particular when manufacturing panels having a decorative top layer comprising a digitally printed pattern, such as a pattern comprised on a digitally printed decorative sheet, or a pattern comprising a print performed on the substrate material or board, for example with the intermediary of one or more preparatory layers.

Therefore, the present invention in accordance with its second independent aspect is a method for manufacturing panels, wherein said panels comprise a substrate and a decorative top layer, wherein said decorative top layer comprises a digitally printed decorative sheet and possibly additionally a wear layer applied on top of said printed decorative sheet, wherein said decorative top layer comprises one or more lateral edges, and wherein said method at least comprises the step of machining at least one of said lateral edges of said decorative top layer by means of a rotating milling cutter, with as a characteristic that said rotating milling cutter shows one or a combination of two or more of the following properties:
the property that the axis of said rotating milling cutter is tilted with respect to said lateral edge in a first plane comprising said decorative top layer, to thereby form a first angle of preferably between 0 and 30° with the normal of said lateral edge, and more preferably between 1 and 10°, wherein said first angle is preferably such that, as seen from the motor driving said axis, said axis is pointing into the direction of a portion of said lateral edge that is machined;
the property that the axis of said rotating milling cutter is tilted in a second plane perpendicular to said edge, to thereby form a second angle of preferably between 0 and 30° with said first plane, and more preferably between 1 and 10°;
the property that in said step of machining said panel is moved in a feeding direction into engagement with and over said rotating milling cutter, wherein the cutting action of said rotating milling cutter is mainly in said feed direction.

It is clear that the invention of the second aspect may be combined with the invention of the first aspect, and/or the preferred embodiments thereof without the axis of said rotating milling cutter necessarily be tilted with respect to said lateral edge in a first plane comprising said decorative top layer and/or without the axis of said rotating milling cutter necessarily be tilted in a second plane perpendicular to said edge.

Preferably, the method of the second aspect is applied for manufacturing panels having a decorative top layer comprising paper and thermohardened resin. It preferably concerns panels obtained via the DPL process described in connection with the first aspect of the invention.

It is further clear that the invention also relates to a panel obtained or obtainable by means of a method in accordance with the first and/or the second aspect, and/or their preferred embodiments.

With the intention of better showing the characteristics of the invention, hereafter, as examples without any limitative character, some preferred embodiments are described, with reference to the accompanying drawings, wherein:

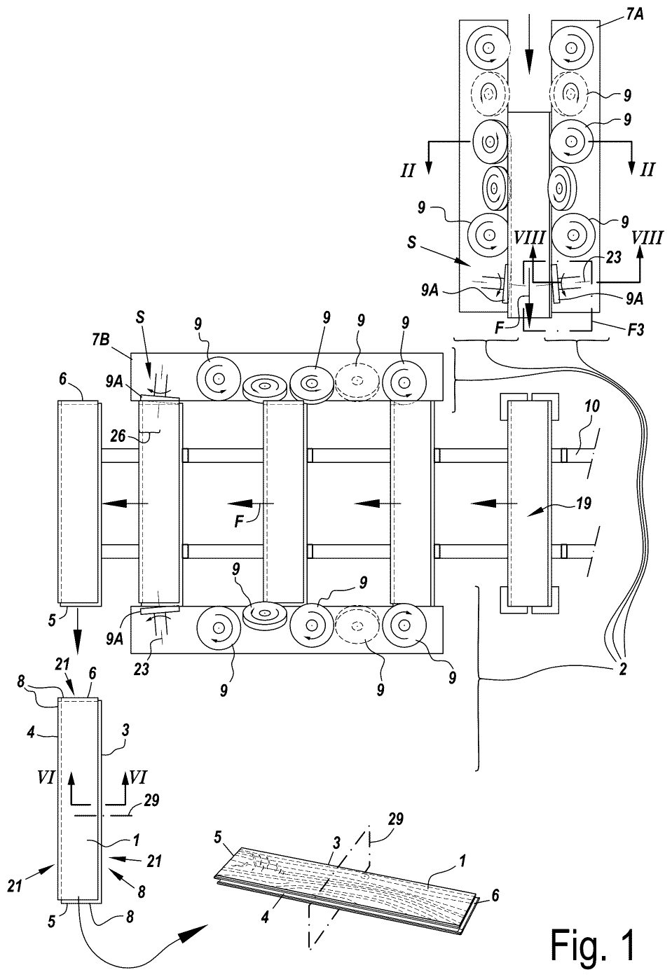

FIG. 1 schematically illustrates some steps in a method in accordance with the invention;

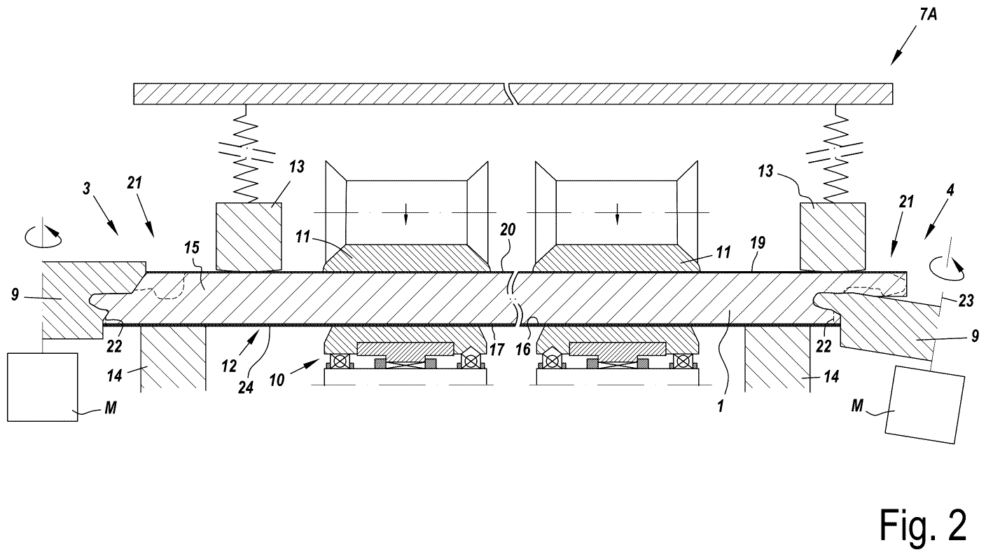

FIG. 2 at a larger scale represents a cross-section in accordance with the line IIII in FIG. 1;

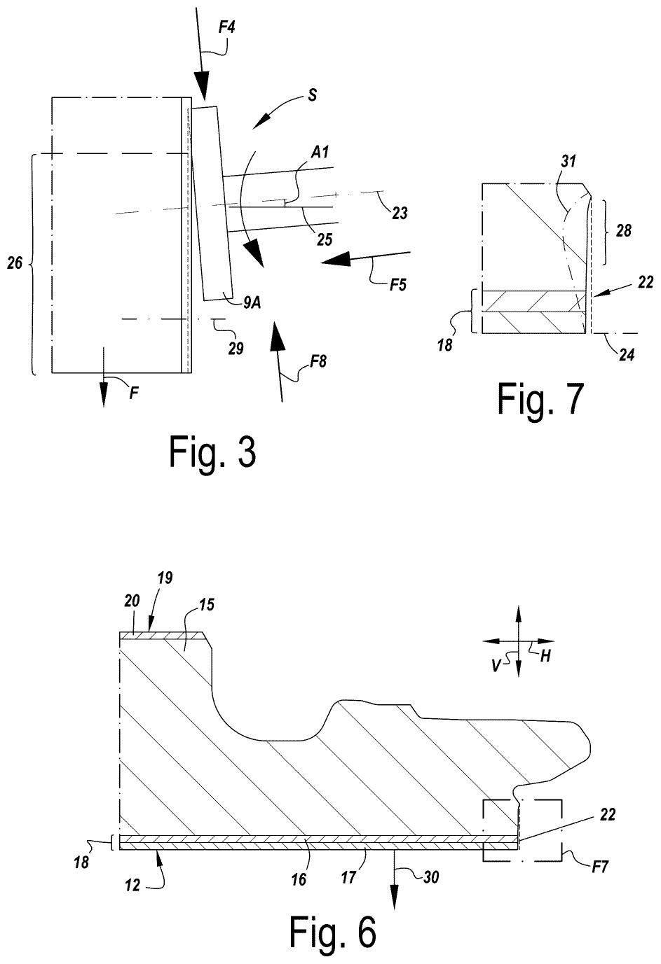

FIG. 3 at a larger scale shows a view on the area indicated with F3 in FIG. 1;

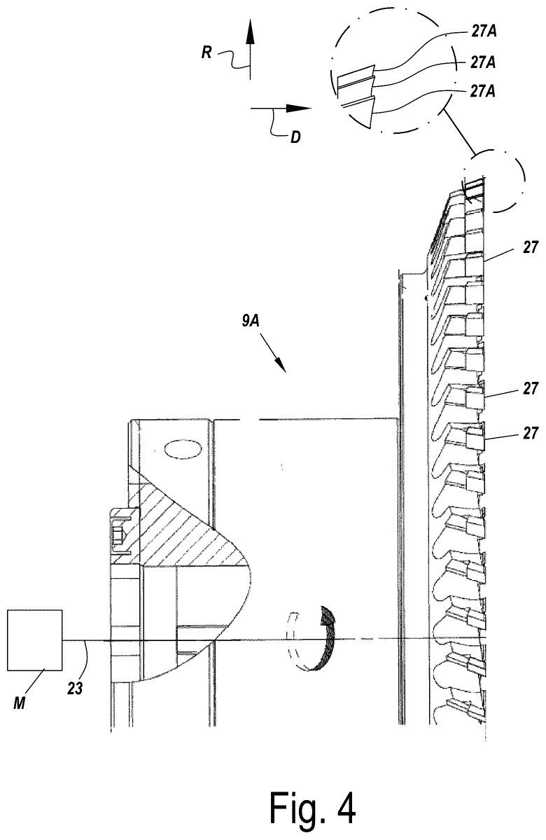

FIG. 4 at a larger scale shows a view on the rotating milling tool of FIG. 3 in accordance with the arrow F4;

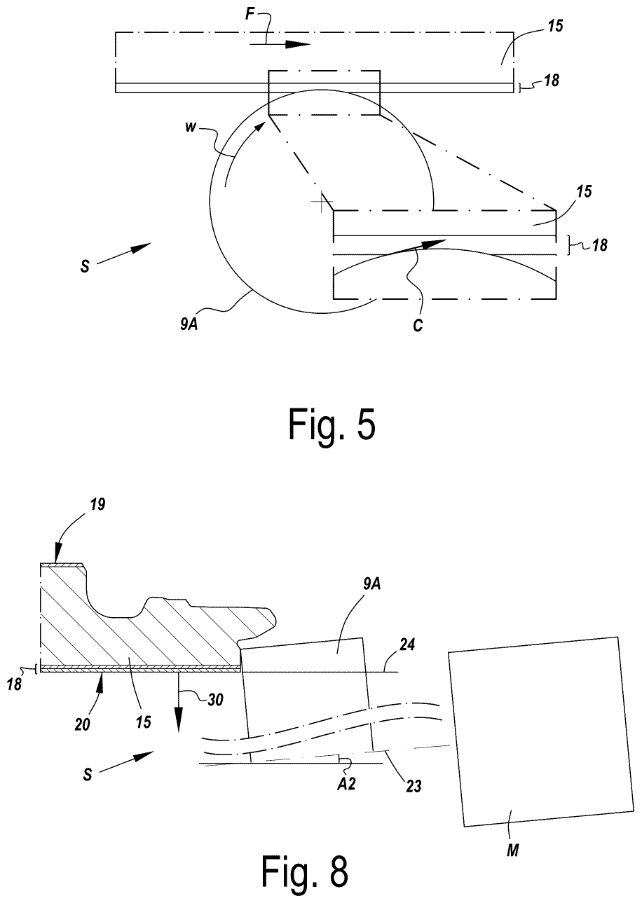

FIG. 5 at a larger scale shows a view in accordance with the arrow F5 in FIG. 3.

FIG. 6 at a larger scale represents a cross-section in accordance with the line VI-VI in FIG. 1;

FIG. 7 at a larger scale shows a view on the area indicated with F7 in FIG. 6;

FIG. 8 at a larger scale shows a cross-section in accordance with the line VIIIVIII in FIG. 1, but for an alternative.

FIG. 1 schematically shows how floor panels 1 can be obtained by means of a method in accordance with the invention. Herein a set 2 of milling tools is used.

In the represented example, the method is applied for manufacturing rectangular panels 1, wherein the floor panels I are at their long pair of opposite sides 3-4, as well as at their short pair of opposite sides 5-6 provided, by means of two machines, more particularly continuous milling machines 7 A-7B, provided with profiled edge areas 8. Firstly the panels 1 are transported with their longitudinal pair of edges 3-4 over the mechanical cutting tools or milling cutters 9. Subsequently their short pair of opposite edges 5-6 is subjected to similar operations.

FIG. 2 shows how such panels 1 are transported through the first continuous milling machine 7 A. The machine 7 A of the example comprises a chain transport 10 and belts, more particularly upper belts 11, just as the machine 7B of the example does. The panels 1 are transported upside down, i.e. with their decorative side 12 facing downward, against the chain transport 10. At their edges 3-4 the panels 1 are pushed by means of pressure shoes 13 with their decorative side 12 on the guiding shoes 14.

The shown panels I comprise a decorative top layer of the “DPL” type. The represented panels 1 comprise a substrate 15, a digitally printed decorative paper 16, as well as a socalled overlay 17 or wear layer, wherein the printed decorative paper 16 and the overlay 17 commonly form the decorative top layer 18, and consist of paper sheets provided or impregnated with synthetic material, more particularly a thermohardening resin. The substrate is a wood-based material board, such as an MDF or HDF board. At their bottom side 19, which as represented here during the machining is facing upwards, the panels 1 are provided with a backing layer 20, that comprises paper and thermohardening resin as well.

FIG. 2 shows that the profiled edge areas 8 to be formed at the long pair of opposite edges 3-4 comprise coupling means or coupling parts 21, by means two such panels 1 at the respective edges 3-4 can be coupled to each other. This is also the case for the to be formed profiled edge areas 8 at the short pair of opposite edges 5-6.

FIG. 3 shows that, in accordance with the invention, the method comprises at least the step S of machine at least one of the lateral edges 22 of said decorative top layer 18 by means of a rotating milling cutter 9A. In the example, the axis 23 of the rotating milling cutter 9A is tilted with respect to said lateral edge 22 in the first plane 24 comprising the decorative top layer 18, i.e. parallel to the general extension of the decorative top layer 18. The axis 23 thereby forms a first angle Al with the normal 25 of said lateral edge 22. As seen from the motor M driving said axis 23, said axis 23 is pointing into the direction of the portion 26 of said lateral edge 22 that is machined.

FIG. 4 shows that the rotating milling cutter 9A comprises a plurality of cutting edges 27, wherein these cutting edges are perpendicular to said axis 23. The dashed-dotted circular area in FIG. 4 illustrates a variant, wherein said cutting edges 27 A, are profiled such that, in the radial direction R, the cutting edges 27 A, in the axis direction D, away from the motor M driving the axis 23. Preferably, said cutting edges 27 A have a parabolic shape.

FIG. 5 clearly illustrates that rotation W of the rotating milling cutter 9 A is such that the cutting action of said rotating milling cutter 9A is mainly in said feed direction F.

The enlarged inserted view shows that the cutting force C presses the decorative top layer 18 towards the substrate 15.

FIGS. 6 and 7 show the undesired effect mentioned in the introduction that may be obtained when a rotating milling cutter 9A is used with cutting edges 27 perpendicular to the axis 23, and when the axis is in said first plane 24. The profile cut in the substrate comprises a portion 28 that extends in the horizontal direction H distally beyond said lateral edge 22 of said decorative top layer 18.

FIG. 8 shows that the axis 23 may assume a second tilt in a second plane 29 perpendicular to said edge to thereby form a second angle A2 with said first plane 24.

This angle is preferably between 1 and 10°, for example 2 to 4°. In this case, the angle A2 is such that, as seen from the motor M, the axis 23 is pointing into the direction of the normal 30 of said decorative top layer 18, or of the general plane in which the decorative top layer 18 extends. By doing so, the undesirable effect shown in FIGS. 6 and 7 may be compensated. A slight undercut, as shown in exaggerated manner with the dash-dotted line 31 in FIG. 7, may be formed below said lateral edge 22. A similar effect or a straight profile may be obtained with the variant of the rotating milling cutter 9A shown in the insert of FIG. 4 and having the profiled cutting edges 27A, even when the axis 23 of the rotating milling cutter is in the first plane 24.

It is clear that the coupling parts 21 illustrated in the example, e.g. in FIGS. 2, 6 and 8, allow to couple to such panels at the respective edges 3-4, 5-6, wherein in a coupled condition a locking is obtained both in a horizontal direction H in the first plane 24, and in a vertical direction Vin said second plane 24.

The present invention is in no way limited to the embodiments described by way of example and represented in the figures; on the contrary such methods and panels may be realized according to various variants without leaving the scope of the invention.

1.-18. (canceled)

19. A method for manufacturing panels, wherein said panels comprise a substrate and a decorative top layer,
wherein said decorative top layer comprises one or more lateral edges, and
wherein said method at least comprises the step of machining at least one of said lateral edges of said decorative top layer by means of a rotating milling cutter,
wherein the axis of said rotating milling cutter is tilted with respect to said lateral edge in a first plane comprising said decorative top layer to thereby form a first angle with the normal of said lateral edge and/or is tilted in a second plane perpendicular to said lateral edge to thereby form a second angle with said first plane.

20. The method according to claim 19, wherein said decorative top layer comprises a printed decorative sheet, and additionally a wear layer applied on top of said printed decorative sheet.

21. The method according to claim 19, wherein said decorative top layer comprises thermohardening resin.

22. The method according to claim 19, wherein the axis of said rotating milling cutter is tilted with respect to said lateral edge in said first plane,
wherein said first angle is between 0° and 30°.

23. The method according to claim 22, wherein said first angle is between 1° and 10°.

24. The method according to claim 22, wherein said first angle is such that, as seen from the motor driving said axis, said axis is pointing into the direction of a portion of said lateral edge that is machined.

25. The method according to claim 19, wherein the axis of said rotating milling cutter is tilted in said second plane,
wherein said second angle is between 0° and 30°.

26. The method according to claim 25, wherein said second angle is between 1° and 10°.

27. The method according to claim 25, wherein said second angle is such that, as seen from the motor driving said axis, said axis is pointing into the direction of the normal of said decorative top layer.

28. The method according to claim 19, wherein the axis of said rotating milling cutter is in said first plane.

29. The method according to claim 19, wherein said rotating milling cutter comprises one or more cutting edges,
wherein said cutting edges are perpendicular, or nearly perpendicular to said axis.

30. The method according to claim 19, wherein said rotating milling cutter comprises one or more cutting edges,
wherein said cutting edges are profiled such that, in the radial direction, the cutting edge extends, in the axis direction, away from the motor driving said axis.

31. The method according to claim 19, wherein in said step of machining said panel is moved in a feeding direction into engagement with and over said rotating milling cutter.

32. The method according to claim 31, wherein the cutting action of said rotating milling cutter is mainly in said feed direction.

33. The method according to claim 19, wherein said panels comprise at least one pair of opposite edges,
wherein said opposite edges comprise profiled edge regions having mechanical coupling means allowing to couple at least two such panels at the respective edges,
wherein in a coupled condition a locking is obtained in a plane comprising the panels and perpendicular to the respective edges, and/or in a plane perpendicular to the respective edges.

34. The method according to claim 33, wherein, in said coupled condition, lateral edges of the decorative top layer of the respective panels meet each other without play or with a play smaller than 0.15 mm.

35. A method for manufacturing panels, wherein said panels comprise a substrate and a decorative top layer,
wherein said decorative top layer comprises a digitally printed decorative sheet and additionally a wear layer applied on top of said printed decorative sheet,
wherein said decorative top layer comprises one or more lateral edges, and
wherein said method at least comprises the step of machining at least one of said lateral edges of said decorative top layer by means of a rotating milling cutter,
wherein said rotating milling cutter shows one or a combination of two or more of the following properties:
the property that the axis of said rotating milling cutter is tilted with respect to said lateral edge in a first plane comprising said decorative top layer, to thereby form a first angle of between 0° and 30° with the normal of said lateral edge,
wherein said first angle is such that, as seen from the motor driving said axis, said axis is pointing into the direction of a portion of said lateral edge that is machined;
the property that the axis of said rotating milling cutter is tilted in a second plane perpendicular to said lateral edge, to thereby form a second angle of between 0° and 30° with said first plane;
the property that in said step of machining said panel is moved in a feeding direction into engagement with and over said rotating milling cutter,
wherein the cutting action of said rotating milling cutter is mainly in said feed direction.
